(19) United States
(12) Patent Application Publication
(10) Pub. No.: US 2017/0251365 A1
(43) Pub. Date: Aug. 31, 2017

(54) CYBER SECURITY

(71) Applicant: pureLiFi Limited, EDINBURGH (GB)

(72) Inventors: Harald Burchardt, Edinburgh (GB); Nikola Serafimovski, Edinburgh (GB)

(21) Appl. No.: 15/509,803

(22) PCT Filed: Sep. 8, 2015
(86) PCT No.: PCT/GB2015/052592

§ 371 Date: Mar. 8, 2017

(30) Foreign Application Priority Data
Sep. 8, 2014 (GB) 1415867.9

(51) Int. Cl. H04W 12/06; H04W 12/08; H04B 10/116; H04L 29/06

(52) U.S. Cl. CPC H04W 12/06; H04L 63/107; H04W 12/08; H04L 63/083; H04L 63/0853; H04B 10/116

(57) ABSTRACT

A light enabled security system for allowing a user device access to files or data on a network, each user device having a user ID and each file/data having a file/data ID. The system has a plurality of light enabled user access points for allowing access to the network via a light communication channel, each light enabled user access point being associated with a unique location ID, and each being operable to construct a network access request in response to a file/data request from a user device, the network access request including the user device ID, the unique user access point location ID and the requested file ID. The system is adapted to receive the network access request and use it to determine whether access to the file/data is allowed or denied based on the user ID, the location ID and the file ID.

### FIELD OF THE INVENTION

The present invention relates to wireless security, and in particular light based wireless security.

### BACKGROUND OF THE INVENTION

Internet access significantly improves the productivity of any organization. However, it also creates a conduit for potentially malicious actors to penetrate the network through hacking and social engineering. Therefore, in response, administrators are partitioning network access and limiting the access of every user to a particular sub-set. While this increases security by limiting the attack surface of an organization and exposure, it does not address the weakest aspect of the cyber security chain: the human user.

Most successful network intrusions occur due to the human factor in the security chain. According to the 2013 Information Security Breaches Survey conducted by PWC for the Department for Business Innovation & Skills with the UK government, over 45% of the worst security breaches in a company were a result of human error. In addition, there are a number of articles that indicate that social engineering, getting a human to help you, is the easiest method to hack an organization. Therefore, in addition to introducing system level encryption for the employee devices, organizations are looking at optimizing their security by leveraging statistical pattern recognition models for employee behaviour. Significant research is aimed at creating user behaviour models to track and correlate data in an attempt to detect anomalous events. The user data ranges from GPS location, to network access and file/Internet browsing characteristics. However, the data analysis is cumbersome and takes time. Therefore, many state-of-the-art malware and intrusion detection algorithms raise alarms after a system has been compromised.

In response, similar to the way banks monitor client transactions, organizations are deploying algorithms that monitor the network and employee behaviour. To facilitate these models, organizations want to track the exact location of their employees and assets while they are on the premises to guarantee that only the appropriate individuals access the appropriate information from the appropriate location at the appropriate time. Physical access controls, such as biometrically controlled doors and closed circuit TV cameras are often used to partition indoor environments. However, such partitioning limits the mobility within an organization and is not favourable to real-time asset tracking. Current indoor localization is inaccurate and, even with the latest tracking protocols, wireless access points that connect to the network backbone are needed. These can become points of weakness, vulnerable to sniffing and penetration.

### SUMMARY OF THE INVENTION

According to a first aspect of the invention, there is provided a light enabled security system for allowing a user device access to files or data on a network, each user device having a user ID and each file/data having a file/data ID, the system comprising: a plurality of light enabled user access points for allowing access to the network via a light communication channel, each light enabled user access point being associated with a unique location ID, and each being operable to construct a network access request in response to a file/data request from a user device, the network access request including the user device ID, the unique user access point location ID and the requested file ID, and a system adapted to receive the network access request and use it to determine whether access to the file/data is allowed or denied based on the user ID, the location ID and the file ID.

Preferably, a plurality of light enabled portable user devices is provided for communicating with the access point using light, each device being associated with a unique user ID.

The present invention uses a light enabled Li-Fi network. This introduces a bridge between the physical realm and cyber space. Li-Fi uses visible light for communications. Visible light, including near ultra-violet and infra-red wavelengths, cannot penetrate opaque objects, which means that the wireless signal is constrained within a strictly defined area of illumination. The ability to confine the communication area of a Li-Fi access point allows precise partitioning of the environment. In addition, the technology requires proprietary hardware before anyone can access the system. Finally, a Li-Fi network deployed in a cellular fashion can be used to improve asset tracking within an organization and improve the user behaviour statistics deployed as well as precisely limit user network access.

Every user can be mobile by using a dedicated light enabled portable user access device or a desktop unit as a token. In addition, the number of possible active users can be strictly monitored and controlled, since every user requires a desktop unit to access the network.

Each light enabled portable user device may be operable to transmit to the light enabled user access points using light of a first wavelength and receive from the light enabled user access points light of a second, different wavelength. An advantage of this is that there is no possibility that one employee can ‘hear’ information sent to the server from another employee, since the uplink communication is on an entirely different frequency from the downlink. In this embodiment, every desktop unit (and access point) has a built-in transceiver that permits two way communications.

Another advantage is that every file can have a simultaneous “dual-gate locking system”. One gate is unlocked with traditional/existing authentication methods, while the other is unlocked based on the specific location of the device that is requesting access to the file, i.e., the specific access point and user device combination that is requesting access. The location controlled gate can be on a standalone, physically separate server. In this manner, as long as the physical assets are protected, the probability of network intrusion is significantly reduced. This also creates a barrier which permits external network access for the employees, while preventing network intrusions from outsiders.

Network access can be controlled to permit file access only if a device is connected to the Li-Fi network. Once a user connects to the Li-Fi network, they can download and modify certain files on their machine. Files that are downloaded may be encrypted. For example, files may be encrypted with a high level of hardware facilitated encryption on the access point they have been accessed from, with software monitoring the connection to the network. As soon as the user disconnects from a Li-Fi access point, the network controlled software can either completely delete the file and any trace of the working session or leave an encrypted copy of the working session. This results in those (potentially already downloaded) files being inaccessible except when connected to the particular access point they were downloaded from. Therefore, any file access may require that the users are connected to the Li-Fi network, preventing external access to the network and, hence, minimizing the vulnerability of the organization.

An additional form of hardware facilitated encryption may be made available through the desktop unit (as opposed to the access point). By facilitating hard-coded encryption/decryption on the desktop unit, it is possible for files on the network to be secured from access by any desktop unit except the intended one. This can be done mainly in two ways: (hardware-based) the file may be uploaded to the network from the desktop unit, which encrypts the file such that it only becomes accessible from the same particular desktop unit; or (software-based) the public key of the intended desktop unit may be used on a different device to encrypt the file when uploading to the network, such that, again, only the intended desktop unit, which has access to the relevant private key, can access the file.

In practice, two layers of hardware-enabled encryption can be implemented, where access point encryption ties access to a particular location, and desktop unit encryption ties access to a particular user or device.

The system of the invention may be adapted to identify a current location of a user device; define a group or set of light enabled access points in the vicinity of the user device from which access is permitted and store details of that group. Every device that can connect to the network can be localized and tracked. This allows so-called geo-fencing to be implemented where the movement and connection of every device can be monitored, and the physical access area of the device is constrained to the currently connected and neighbouring access points. Access to files can be made available only under designated Li-Fi access points. Asset tracking can also be implemented based on geo-fencing principles.

The security system of the invention may be adapted to store information relating to a user's use of the system and use that information to identify potentially anomalous behaviour. Statistical models for user behaviour can be developed based on monitoring the network activity of the users, as well as the movement patterns of the employees that are using them. Employee behaviour can be monitored in a more precise and more informative manner due to the localization information provided by the Li-Fi network. This modelling can significantly improve the system security by drawing attention to an anomalous effect in real-time rather than in post processing.

The system may comprise a plurality of light enabled portable user devices for communicating with the access point using light, each device being associated with a unique user ID. Each light enabled portable user device may be operable to transmit to the light enabled user access points using light of a first wavelength and receive from the light enabled user access points light of a second, different wavelength.

A plurality of secure wireless networks may be defined using the light enabled user access points, wherein each access point has a spatial coverage limited by its area of illumination and/or physical structure in its vicinity, such as walls or ceilings, through which light cannot penetrate.

The system may be adapted to determine whether access is allowed or denied using (1) the user ID and the file ID, and (2) the user ID and the location ID. In this case, the system may have a first processor or server adapted to determine whether access is allowed or denied using the user ID and the file ID, and a second processor or server adapted to determine whether access is allowed or denied using the user ID and the location ID.

The system may be adapted to determine first whether access is allowed or denied using the user ID and the file ID, and if it is then subsequently determine whether access is allowed or denied using the user ID and the location ID.

The system may be adapted to determine whether access is allowed or denied using (1) the user ID and the file ID, and (2) the file ID and the location ID. In this case, the system may have a first processor or server adapted to determine whether access is allowed or denied using the user ID and the file ID, and a second processor or server adapted to determine whether access is allowed or denied using the file ID and the location ID. The system may be adapted to determine first whether access is allowed or denied using the user ID and the file ID, and if it is then subsequently determine whether access is allowed or denied using the file ID and the location ID.

The system may be adapted to identify a current location of a user device; define a group or set of light enabled user access points in the vicinity of the user device from which access is permitted and store details of that group.

The system may be adapted to continuously monitor a user's location and update the group or set of light enabled user access points from which access is permitted.

The system may be adapted to identify any attempt to access the network from an access point outside the defined group or set of light enabled user access points in the vicinity of the user device. The system may be adapted to create an alert indicative of illegal access in the event that an attempt to access the network is identified.

The system may be adapted to store information relating to a user's use of the system and use that information to identify potentially anomalous behaviour.

The system may be adapted to store details of the location of the user device, so that the user device is trackable. Each access point may be associated with an indoor location, for example a specific room or area within a building.

At least one light enabled access point may be associated with an encrypted file, and decryption of that file may be possible only when the user device is connected to said at least one light enabled access point. The at least one light enabled access point may be operable to encrypt the file.

The at least one light enabled access point may be operable to delete a file from a user device in the event that a connection is broken between the user device and the access point.

In the event that a connection is broken between the user device and the access point, only the encrypted file may be available using the user device.

At least one user device may be associated with an encrypted file or data, and that file or data may be accessed only by said user device.

At least one user device may include encryption and/or decryption hardware or software.

Each user access point may be operable to receive light of different wavelengths, wherein each wavelength is associated with a different level of access.

According to another aspect of the invention, there is provided a light enabled portable user device for use in a system of the first aspect, wherein the device is operable to send with a network access request a user ID and a file ID.

### BRIEF DESCRIPTION OF THE DRAWINGS

Various aspects of the invention will now be described by way of example only and with reference to the accompanying drawings, of which:

FIG. 1 is a block diagram of a visible light enabled security system;

FIG. 2 is a schematic illustration of physical security aspects of a visible light enabled system;

FIG. 3 is a block diagram of a dual gate access system;

FIG. 4 is a flow diagram of a method for implementing dual gate access using the system of FIG. 3;

FIG. 5 is a block diagram of a Geo-fencing access system

FIG. 6 is a flow diagram of a method for implementing Geo-fencing access using the system of FIG. 5;

FIG. 7 is a block diagram of a behavioural analysis system, and

FIG. 8 is a flow diagram of a method for implementing behavioural analysis access using the system of FIG. 7.

### DETAILED DESCRIPTION OF THE DRAWINGS

The present invention provides a light enabled access system that uses lights as secure network access points. All lighting must be Li-Fi enabled. Each Li-Fi access point is connected with cabling which will deliver data and network access. This cabling may also deliver power to the Li-Fi access points which are also referred to as ceiling units. Each ceiling unit connects to one or more LED lighting fixtures to provide power and modulate the light to deliver data. The physical connectivity of the ceiling units depends on the logical partitioning of an environment. Following the installation of the ceiling units, each user is assigned with a desktop unit. Each desktop unit facilitates hardware enabled encryption. Each desktop unit has a receiver for receiving visible light signals at a first wavelength from the ceiling units and a transmitter for transmitting at a second wavelength to the ceiling units. Each ceiling unit has a transmitter for sending visible light signals at the first wavelength to the desktop units and a receiver for receiving at the second wavelength from the desktop units.

For the avoidance of doubt, and throughout this patent, “visible light” will refer to those electromagnetic waves with wavelengths 10 nm to 2500 nm, and which includes the ultraviolet, visible light and near-infrared wavelengths.

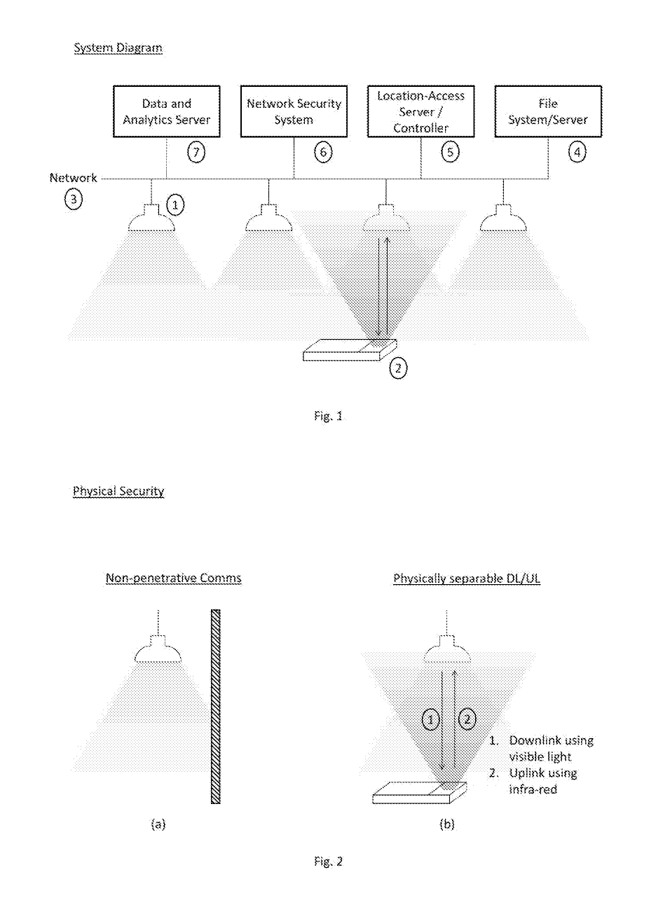

FIG. 1 shows a Li-Fi access system, network and network control system. The system has a plurality of Li-Fi-enabled LED lamps 1 that function as wireless access points to allow user Li-Fi desktop units 2 access to the network 3. Associated with each light/lamp is a ceiling unit (not shown). The network 3 is accessible through each access point 1 in the area that it illuminates, or, the “coverage area”. Each ceiling unit is connected to the network 3 via an Ethernet cable and interfaces directly with the IP layer. The ceiling unit exploits the visible (white) light generated for illumination as the communication medium.

Each Li-Fi desktop unit is operable to connect, for example via a USB, to a computing device (e.g., laptop, tablet, smartphone, etc.) in order to provide that device access to the network. The desktop unit receives the information signal communicated over the white light signal, and feeds this to the device. The desktop unit utilises infra-red LEDs in order to communicate the uplink channel to the Li-Fi ceiling unit(s). Multiple desktop units can access the same ceiling unit simultaneously, and a desktop unit can move from the coverage area of one ceiling unit to another without dropping its connection.

The network 3 is comprised of an interconnection of Ethernet switches and cables, providing data to and from every access point 1. Secure access to the network 3 is provided via the Li-Fi ceiling units (and direct Ethernet ports). The network 3 is configured in a star topology, with a single Ethernet cable serving each ceiling unit.

Connected to the network 3 is central system that has a File System/Server 4, a Location-Access Server 5, a Network Security System 6 and a data and analytics server 7.

The File System/Server 4 is the main host of all the files to be accessed by users of the system. This includes both secure and non-secure files. The File System/Server 4 is assumed to contain and contend with traditional authentication/authorisation mechanisms (i.e., username and password matching), user access level information (e.g., which usernames can access what parts of the File System, Microsoft Active Directory, etc.), two-factor authentication and other aspects.

To control secure access to the network 3, the Location-Access Server/Controller 5 is provided. This hosts location-specific (in the case of Li-Fi, IP/MAC address(es) of authorised ceiling units) access credentials of all individual files (that are location-locked). It also hosts the location specific access credentials of each user, i.e., what ceiling units the user is authorised to access the network 3 from. The former information is utilised for Dual-Gate Locking, the latter for Geo-Fencing. This will be described in more detail later.

When a user attempts to access a particular file from a particular access point, the File System/Server 4 queries the Location-Access Server 5 with the User ID, File ID, and Location ID (access point IP/ID). The Location-Access Server 5 determines whether the file (associated with the File ID) can be accessed from the particular access point (associated with the Location ID); or the user (associated with the User ID) has authorised access from the particular access point; or both of the above. Therefore, the Location-Access Server 5 is the main component for location-based network access. The output of the Location-Access Server 5 is a binary value, signalling the approval or denial of access. In this manner, the location-authorisation information on the Server 5 remains protected.

The Network Security System 6 monitors, detects and protects the system against security breaches and illegal data access.

To store access statistics of the user, files and locations, the Data and Analytics Server 7 is provided. Other parameters may be stored in the Data and Analytics Server 7, such as access time, device(s), etc. On this server, analytics are run on the collected data in order to provide statistical models of the access behaviour of, in particular, system users, but also of the files and access locations. The Data and Analytics Server 7 simply monitors activity on the network 3, and utilises the developed statistical models for anomaly detection and flagging of potential security breaches.

The use of visible light has many attractive qualities in the wireless communications space, particularly in terms of network security. From a very basic perspective, the non-penetrative nature of light constrains the wireless network to the illuminated area. In highly secure environments, this results in the wireless network being contained literally “within the four walls.” FIG. 2(a) shows this, where the solid wall prevents the penetration of the light signal. The non-penetrative property of light substantially reduces the risk of illegal access via the wireless connection. A further security feature of Li-Fi is the physical separation of the downlink and the uplink communication channels on different wavelengths. Because each desktop unit is designed to capture only visible light signals of particular wavelength, a motivated attacker attempting to listen to another user's communication will only ever be able to access half of that transferred information (i.e., the downlink). This is depicted in FIG. 2(b).

In general, enhancing the security of a file system can be achieved by reducing the attack surface of the network 3. This means, minimise the physical area of access to the network 3 as well as the number of applications that are on a user device. This can be done for particular classes of files on the File System 4, and with Li-Fi, different sets of secure files can have completely segregated physical access areas. This comes from the directional and non-penetrative nature of the visible light downlink signals, allowing for a precise demarcation of the physical access areas. This is performed by creating for each file a set of (Li-Fi) access points from which access to the particular file is permitted. Attempting to access the file from any other access point outside the permissible set would result in access to the file being denied (even if the user is authorised to access the file). The location-based access criteria are stored on the Location-Access Server 5, which is a completely physically stand-alone server that solely handles location-based queries.

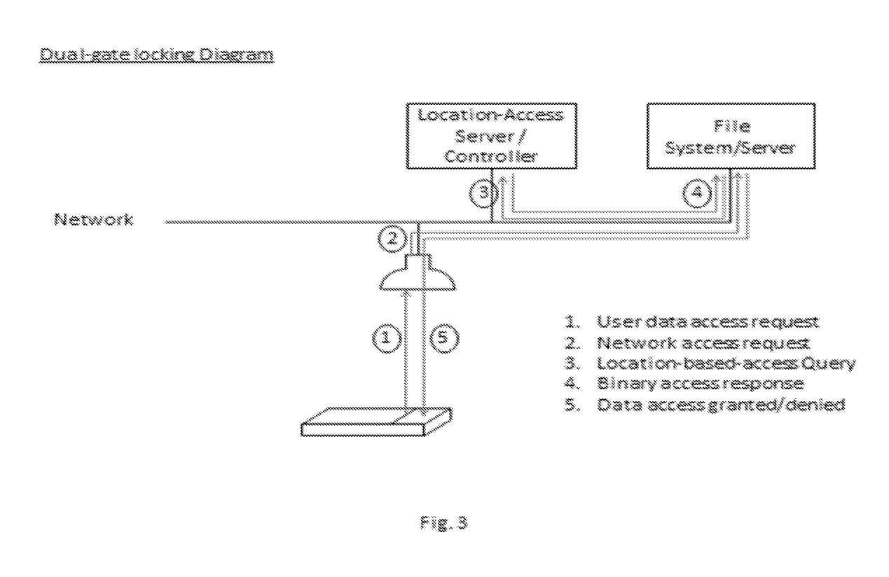

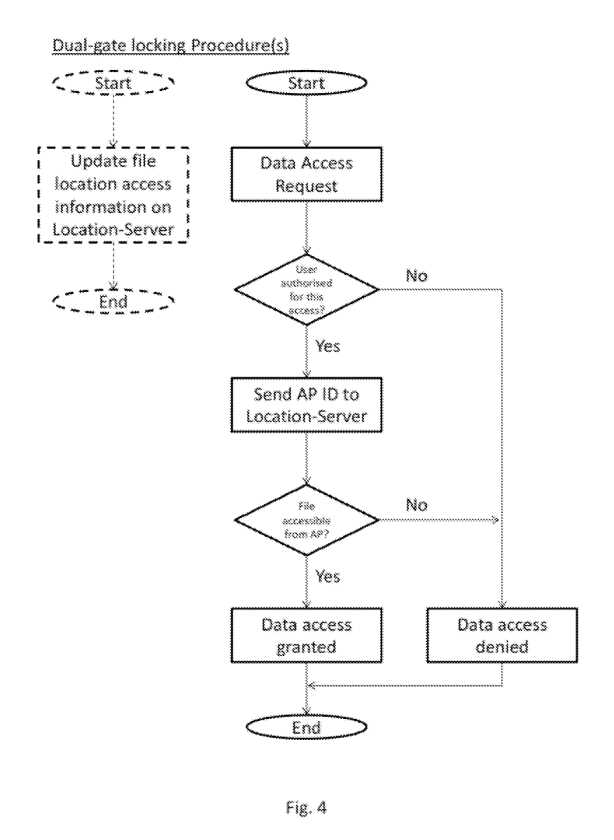

FIG. 3 shows a system for dual gate locking. This has a ceiling unit 1 and a desktop unit 2. The user and location authentication are performed by the File Server and Location-Access Server, respectively. As shown in FIG. 3, a typical message exchange protocol for Dual-Gate Locking involves four five exchanges of information. Firstly, the user, with a particular User ID, requests access to a file, with a particular File ID, from the Li-Fi access point 1 it is currently connected to. This is done by sending a user data request to the connected Li-Fi access point, the user data request including the User ID and the File ID. The access point has a particular Location ID (access point IP/MAC/ID). The access point receives from the user device the user data request and uses this to construct an access request that includes the User ID, the File ID and its own Location ID. This access request is sent to the File System 4. The File System 4 uses the User ID and the File ID to authenticate that the user is authorised to access the file. If this is not the case, the System 4 denies data access. If successful, the File System 4 sends to the Location-Access Server the File ID and Location ID. The Location Access Server 5 checks whether the file is accessible from the access point with a particular Location ID. It responds to the File System 4 with a binary Yes/No response. The File System 4 sends back to the user, over the Li-Fi access point 1 and desktop unit 2 the requested data, if and only if both the User ID (determined by the File Server) and Location ID (determined by the Location-Access Server) are permitted access to the file. Otherwise, access to the particular data is denied. FIG. 4 shows a flowchart depicting the above flow of information.

Physically separate multi-tier security access may be implemented. In this case, different wavelengths can be used to segregate different levels of access, e.g., engineers might have desktop units that are served by green light, while security personnel may be served by blue light and upper management served by red light. The available information is strictly limited and broadcast on distinct channels using the same infrastructure.

Another approach to minimise the physical access area and, consequently, the attack surface of the network 3 is to limit the number of access points that a particular user is permitted to access the network from. This is called a Geo-Fence. In Li-Fi, Geo-Fencing allows for the network to limit each user's access to the network to only the CU/access point it is currently connected to and that access point's immediate neighbours. This serves two main purposes. The access network for a particular User ID at any given time shrinks to a small subset of the total network 3. This significantly diminishes the opportunity for a motivated attacker with stolen user credentials to access the network. The neighbouring access points are enabled in order to allow movement from one access point to the next, at which point the new access point and its neighbours become the access area. This facilitates a network access that moves with the user through the Li-Fi network. This is performed by creating for each User ID, a variable set of (Li-Fi) access points from which access to the network 3 is permitted. Attempting to access the network 3 from any other access point outside the permissible set, and access to the file is denied. The access points forming each user's Geo-Fence are stored on the Location-Access Server, and are continuously updated with every handover the user undergoes when moving through the network 3.

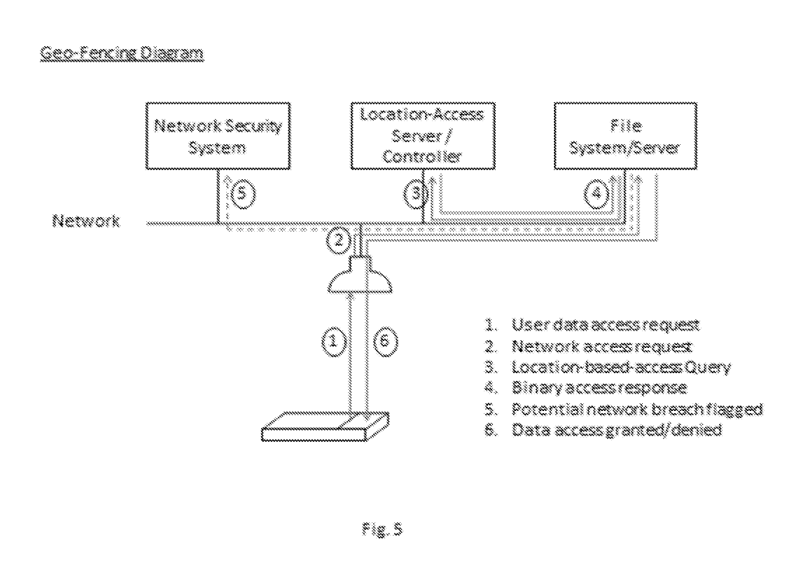

FIG. 5 shows a system for Li-Fi Geo-Fencing. As before, this has a plurality of ceiling units/access points and a desktop unit for each user. User and location authentication are performed by the File Server 4 and Location-Access Server 5, respectively. FIG. 5 shows a typical message exchange protocol for Geo-Fencing. This includes six exchanges of information. The user, with a particular User ID, requests access to a file on the network from the Li-Fi ceiling unit/access point 1 it is currently connected to. This is done by sending a user data request that includes the user ID and File ID to the Li-Fi ceiling unit/access point. The access point has a particular Location ID (access point IP/ID). The access point creates an access request that among other information includes the File ID, the User ID and the Location ID. This request is sent to the File System 4. The File System 4 first authenticates that the User ID is authorised to access the file. If this is not the case, the System 4 denies data access. If successful, the File System 4 sends to the Location-Access Server 5 the User ID and Location ID. The Location Access Server 5 checks whether the access point, with particular Location ID, is in the permissible set of access points for the particular User ID, i.e., within the user's Geo-Fence. It responds to the File System 4 with a binary Yes/No response. If the response from the Location-Access Server 5 is a “No”, then a possible security breach is detected. The File System 4 then notifies the Network Security System 6 of the Location ID and User ID of the attempted illegal access. The File System 4 sends back to the user, over the Li-Fi ceiling unit/access point and desktop unit the requested data, if and only if both the User ID (determined by the File Server) and Location ID (determined by the Location-Access Server) are permitted access to the file. Otherwise, access to the particular data is denied.

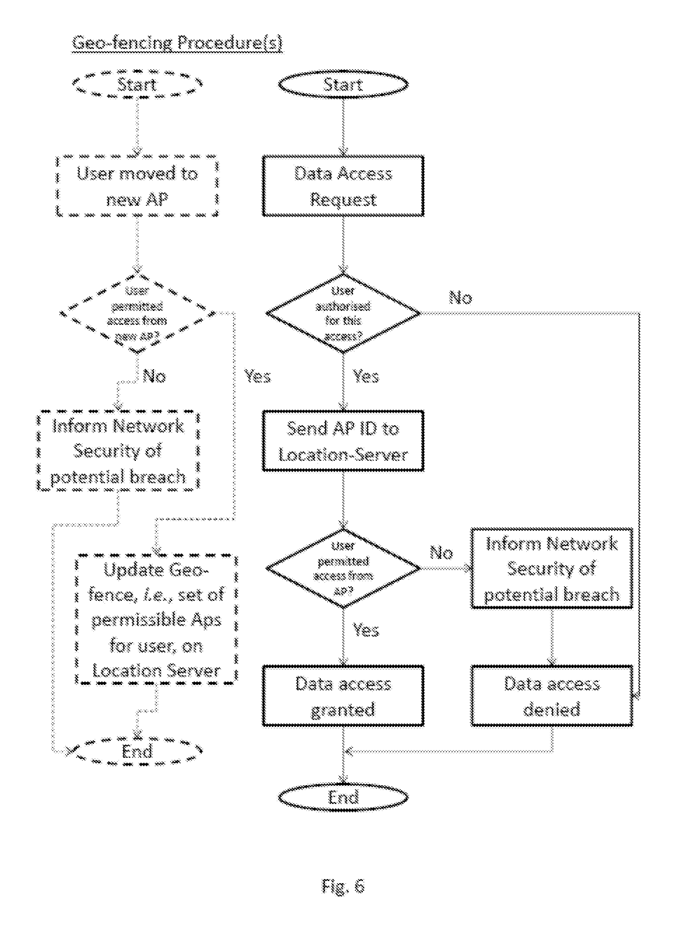

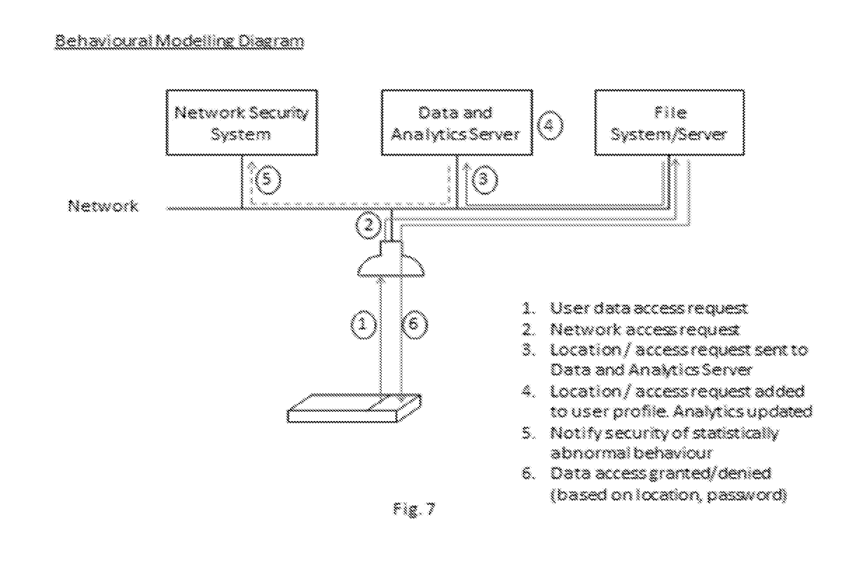

FIG. 6 shows a flow diagram for a Geo-Fencing data access protocol. The dash-lined flowchart represents that basic mechanism by which the set of permissible access points (i.e., Geo-Fence) on the Location-Access Server can be updated when desktop unit connects to a new ceiling unit/access point. This involves monitoring the location of the user, for example checking whether a user has moved to a new access point 1 and checking whether the user is permitted access from that new access point. If yes, then a set of permissible access points, the so called Geo-fence, is defined in the vicinity of the user's current access point. A check performed whether the new ceiling unit/access point is within the previous Geo-Fence or whether this is a foreign/illegal access attempt. Any illegal attempt is notified to the Network Security System 6.

Geo-fencing allows access to the network as a function of where the user is and where he moves to. This is done by activating a specific set of Li-Fi access points in the vicinity of a user's current location and changing this set as a user moves around. For example, if an employee wants to access the network from the conference room, then the system would be trained to see (record) the movement (path) from the employee's usual location to the coffee room. At the beginning, the employee can access the network from the Li-Fi access point (the light) above their desk and the lights immediately neighbouring it. After registering with and being handed over to a neighbouring Li-Fi access point, they are permitted to connect to the next neighbour. From one light to the next, each Li-Fi access point would acknowledge that the employee/user is moving.

By using Geo-fencing, in the Li-Fi system of the present invention, the network access moves with the relevant individual. In traditional systems, in which employees have access to secure files from the network connection at their desk, a motivated attacker can infiltrate the organization and gain access to classified information by using the appropriate credentials. In the Geo-fenced Li-Fi system, the attacker would be able to access the network with the appropriate credentials only in the vicinity of the employee in question. Instead of securing a specific location, the organization may now only secure the relevant users, i.e., physical security becomes relevant in the cyber security domain.

As mentioned previously, the majority of cyber-attacks are the result of social engineering, i.e., the manipulation or exploitation of the human users of a system. While providing additional gating processes can minimise the attack surface of the wireless network, these techniques are less effective against an attack from within. In order to be able to detect and prevent a network security breach that is the result of social engineering, the system needs to establish when a user is behaving abnormally. Due to the high-density of Li-Fi ceiling units/access points, it is possible to precisely determine the current position of a user simply based on the access point the user is connected to. This allows the network 3 to track the user as they move through the network 3. By storing this data, statistical analysis over a large enough data set will provide the system with a model of a user's typical behavioural patterns when accessing the network 3. This behaviour may be compiled from additional data points, such as time of access(es), files accessed, frequency of network access, etc. By establishing an average behavioural model, anomalous behaviour becomes detectable.

FIG. 7 shows a system for Li-Fi Behavioural Modelling. As before, a plurality of ceiling units/access points and a desktop unit are involved in the basic network access. The user authentication is performed by the File Server 4 and anomaly-detection is performed at the Data and Analytics Server 7. FIG. 7 shows a typical message exchange protocol for Behavioural Modelling. The user, with a particular User ID, requests access to the network from the Li-Fi ceiling unit/access point it is currently connected to. This is done by sending from the user device a user data request that includes the user ID and file ID to the Li-Fi ceiling unit/access point. The access point generates an access request using the user ID, file ID and its own Location ID. This access request is sent to the File System 4. The File System 4 first authenticates the User ID is authorised to access the file. If this is not the case, the System 4 denies data access. If successful, the File System 4 sends to the Data and Analytics Server 7 the User ID, Location ID, requested File ID, and any additional desired parameters. The access request information received from the File System 4 is added to the profile of the particular User ID, and factored into a statistical model of the user's network access behaviour.

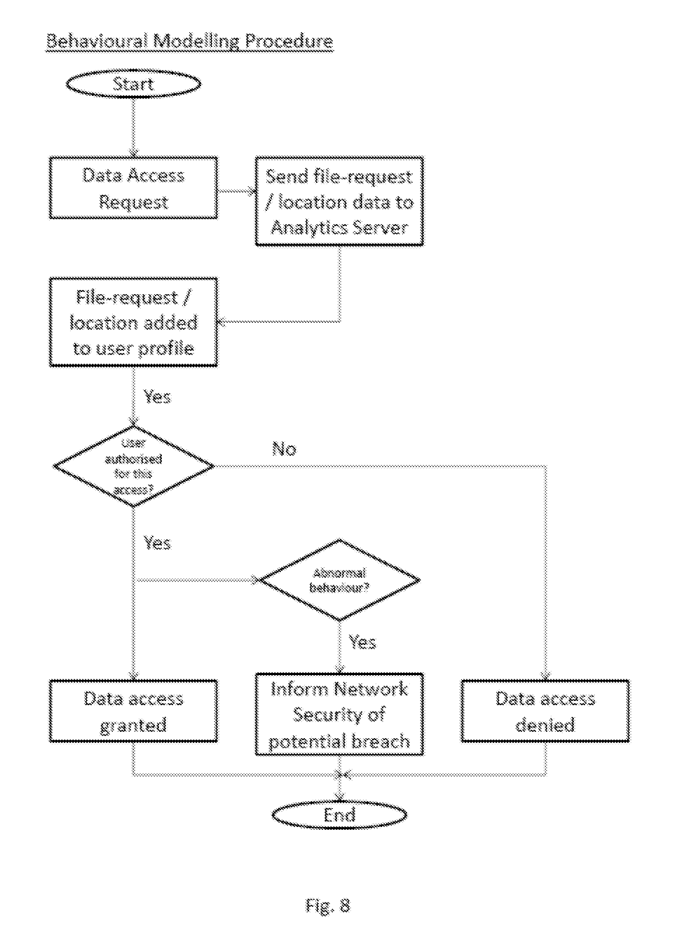

Anomaly detection algorithms investigate whether the current access is abnormal or within the user's general pattern. If the Data and Analytics Server 7 determines an anomalous network access event, then a possible security breach is detected. The Data and Analytics Server 7 then notifies the Network Security System 6 of the Location ID and User ID of the alleged illegal access. The File System 4 sends back to the user, over the Li-Fi ceiling unit/access point 1 and desktop unit 2 the requested data, provided the user is permitted access to the file/data. Otherwise, access to the particular data is denied. A flowchart depicting the above flow of information is shown in FIG. 8.

When an anomalous access to the network is detected, this does not prevent the user from gaining access to the data. While this is a matter of implementation and anomalous network access may result in blocking actions, permitting file access and reporting the incident safeguards against the occasion of a legal anomalous access being blocked by the system. However, the Network Security System 6 is still made aware of the anomalous access in the event that it may be an access resulting from human manipulation/exploitation.

In all of the examples described above further security can be provided by using encryption that is linked to the location of the access point and/or the user device. In the case of the access point, downloaded files are encrypted, for example, with a high level of hardware facilitated encryption on the access point they have been accessed from. Software in the access point monitors connection between the user device and the access point. As soon as the user disconnects from the Li-Fi access point, the network controlled software can delete the file and any trace of the working session or leave an encrypted copy of the working session. This results in potentially already downloaded files being inaccessible except when connected to the particular access point they were downloaded from. Additionally or alternatively, encrypted files may only be accessible by a specific user device/desktop unit with access to the decryption key. This can be done by allowing the user device to encrypt the file so that it is accessible only from the same device or by storing the decryption key in the user device. In this case, a public key of the user device may be used on a different device to encrypt the file when uploading to the network, the intended desktop unit that has the private key can access the file. Therefore, two layers of hardware-enabled encryption can be implemented, where access point encryption ties access to a particular location, and desktop unit encryption ties access to a particular user or device.

Every aspect of the present invention increases the network security of the system as a whole while increasing mobility in the system. In particular, Li-Fi can provide the detailed level of information that is required to make effective predictive statistical user behaviour models which minimize the possibility of human error. In addition, the Li-Fi ceiling unit can also act as a hardware enabling encryption device, ensuring that any file on the host laptop cannot be decrypted outside of the designated premises, i.e., before opening any file, the system will ask for the key from the network which is only available via the Li-Fi access points, providing a detailed log to the network of exactly which information has been accessed. The physical device acts as a key permitting access to the network in general as well as files stored on the local machine.

A skilled person will appreciate that variations of the disclosed arrangements are possible without departing from the invention. Accordingly, the above description of the specific embodiment is made by way of example only and not for the purposes of limitation. It will be clear to the skilled person that minor modifications may be made without significant changes to the operation described.

1. A light enabled security system for allowing a user device access to files or data on a network, each user device having a user ID and each file/data having a file/data ID, the system comprising: a plurality of light enabled user access points for allowing access to the network via a light communication channel, each light enabled user access point being associated with a unique location ID, and each being operable to construct a network access request in response to a file/data request from a user device, the network access request including the user device ID, the unique user access point location ID and the requested file ID, wherein the system is adapted to receive the network access request and use it to determine whether access to the file/data is allowed or denied based on the user ID, the location ID and the file ID.

2. A security system as claimed in claim 1 comprising a plurality of light enabled portable user devices for communicating with the access point using light, each device being associated with a unique user ID.

3. A security system as claimed in claim 1 wherein each light enabled portable user device is operable to transmit to the light enabled user access points using light of a first wavelength and receive from the light enabled user access points light of a second, different wavelength.

4. A security system as claimed in claim 1 wherein a plurality of secure wireless networks is definable using the light enabled user access points, wherein each access point has a spatial coverage limited by its area of illumination and/or physical structure in its vicinity, such as walls or ceilings, through which light cannot penetrate.

5. A security system as claimed in claim 1 wherein the system is adapted to determine whether access is allowed or denied using (1) the user ID and the file ID, and (2) the user ID and the location ID.

6. A security system as claimed in claim 5 wherein the system has a first processor or server adapted to determine whether access is allowed or denied using the user ID and the file ID, and a second processor or server adapted to determine whether access is allowed or denied using the user ID and the location ID.

7. A security system as claimed in claim 5, wherein the system is adapted to determine first whether access is allowed or denied using the user ID and the file ID, and if it is then subsequently determine whether access is allowed or denied using the user ID and the location ID.

8. A security system as claimed in claim 1 wherein the system is adapted to determine whether access is allowed or denied using (1) the user ID and the file ID, and (2) the file ID and the location ID.

9. A security system as claimed in claim 8 wherein the system has a first processor or server adapted to determine whether access is allowed or denied using the user ID and the file ID, and a second processor or server adapted to determine whether access is allowed or denied using the file ID and the location ID.

10. A security system as claimed in claim 8, wherein the system is adapted to determine first whether access is allowed or denied using the user ID and the file ID, and if it is then subsequently determine whether access is allowed or denied using the file ID and the location ID.

11. A security system as claimed in claim 1, wherein the system is adapted to identify a current location of a user device; define a group or set of light enabled user access points in the vicinity of the user device from which access is permitted and store details of that group.

12. A security system as claimed in claim 11, wherein the system is adapted to continuously monitor a user's location and update the group or set of light enabled user access points from which access is permitted.

13. A security system as claimed in claim 11, wherein the system is adapted to identify any attempt to access the network from an access point outside the defined group or set of light enabled user access points in the vicinity of the user device.

14. A security system as claimed in claim 13, wherein the system is adapted to create an alert indicative of illegal access in the event that an attempt to access the network is identified.

15. A security system as claimed in claim 1, wherein the system is adapted to store information relating to a user's use of the system and use that information to identify potentially anomalous behaviour.

16. A security system as claimed in claim 1, wherein the system is adapted to store details of the location of the user device, so that the user device is trackable.

17. A security system as claimed in claim 16 wherein each access point is associated with an indoor location, for example a specific room or area within a building.

18. A security system as claimed in claim 1 wherein at least one light enabled access point is associated with an encrypted file, and decryption of that file is only possible when the user device is connected to said at least one light enabled access point.

19. A security system as claimed in claim 18 wherein the at least one light enabled access point is operable to encrypt the file.

20. A security system as claimed in claim 18 wherein the at least one light enabled access point is operable to delete a file from a user device in the event that a connection is broken between the user device and the access point.

21. A security system as claimed in claim 18 wherein in the event that a connection is broken between the user device and the access point, only the encrypted file is available using the user device.

22. A security system as claimed in claim 1 wherein at least one user device is associated with an encrypted file or data, and that file or data is only accessible by said user device.

23. A security system as claimed in claim 1 wherein said at least one user device includes encryption and/or decryption hardware or software.

24. A security system as claimed in claim 1 wherein the user access point is operable to receive light of different wavelengths, wherein each wavelength is associated with a different level of access.

25. A light enabled portable user device for use in a system as claimed in claim 1, wherein the device is operable to send with a network request a user ID and a file ID.
